(19) United States
(12) Patent Application Publication
(10) Pub. No.: US 2022/0161373 A1
(43) Pub. Date: May 26, 2022

(54) SCRAPER FOR REMOVING A WELDED MATERIAL ADHERING TO A WORK PIECE

(71) Applicant: SEVENTY EIGHT Co., Ltd., Osaka (JP)

(72) Inventor: Tetsuya MIZUTANI, Osaka (JP)

(21) Appl. No.: 17/527,506

(22) Filed: Nov. 16, 2021

(30) Foreign Application Priority Data
Nov. 24, 2020 (JP) 2020-194186

(51) Int. Cl. B23K 37/08

(52) U.S. Cl. CPC B23K 37/08

(57) ABSTRACT

A scraper that can accurately scrape fusing shavings without the cutting edge slipping, comprises a flat blade-shaped blade provided on a front side of the scraper, a striking portion provided on a rear side, and a grip portion provided between the blade and the striking portion, wherein a slit extending in a length direction of the blade is formed on one surface of a plane along a width direction of the blade, the slit is opened at a cutting edge and has side walls and in the length direction. When the cutting edge of the blade is pressed against the welded material adhered to a workpiece by fusing or welding, the welded material is inserted into the slit and hits the side walls when the welded material is scraped from the workpiece, movement of the cutting edge in the width direction is restricted.

This application claims priority of Japanese Patent Application No. 2020-194186 filed Nov. 24, 2020, which is hereby incorporated herein by reference in its entirety.

### FIELDS OF THE INVENTION

The present invention relates to a scraper for removing a welded material adhering to a work piece during welding or fusing. In particular, it relates to a scraper that removes fusing slag generated during fusing.

### BACKGROUND OF THE INVENTION

Conventionally, in order to remove the welded material adhering to the workpiece during welding or fusing, a scraper, having a flat blade-shaped blade provided on a tip side, a striking portion provided on a rear end side, and a grip portion provided between the blade and the striking portion, has been used.

When using the scraper, user grippes the grip portion, presses the cutting edge of the blade against the workpiece to which the welded material adheres, and hits the striking portion with a hammer to push the cutting edge toward the welded material so as to scrape the welded material from the work piece.

### SUMMARY OF THE INVENTION

However, when scraping the welded material such as fusing slag and dross adhering to the work piece during fusing, in the conventional scraper, the cutting edge may slip in the width direction of the blade and come off from the work piece, and in that case, fusing slag cannot be scraped off.

Therefore, an object of the present invention is to provide a scraper capable of accurately scraping fusing slag without slipping the cutting edge.

To solve the above problems, the present invention is a scraper for removing a welded material adhering to a work piece, comprising:

a flat blade-shaped blade provided on a tip side of the scraper,

a striking portion provided on a rear end side,

a grip portion provided between the blade and the striking portion, and

a slit extending in the length direction of the blade, which is formed on one surface of a plane along the width direction of the blade, wherein

the slit has an open at the cutting edge and at least two adjacent side walls in the length direction,

the cutting edge of the blade is pressed against the welded material adhering to the work piece by fusing or welding to scrape the welded material from the work piece,

when the cutting edge of the blade is pressed against the welded material, the side wall surface prevents the blade from moving in the width direction when the welded material is inserted into the slit and comes into contact with the side wall.

In the scraper of the present invention, since a slit that is opened at the cutting edge and has a side wall in the length direction is formed in the blade, a part of the welded material enters the slit when scraping. Then, even if the cutting edge tries to slip, the welded material collides with the side wall of the slit, so that the cutting edge cannot move in the width direction. Therefore, since the cutting edge moves only toward the tip, the welded material can be accurately scraped from the workpiece without slipping.

### BRIEF DESCRIPTION OF THE DRAWINGS

FIG. 1 is a perspective view from the plane side which shows the scraper according to an embodiment of the present invention.

FIG. 2 is a perspective view from a back side of the scraper.

FIG. 3 is a side view of the scraper.

FIG. 4 is an enlarged side view of the scraper.

FIG. 5 is a cross-sectional view taken along line A-A of FIG. 1.

FIG. 6 is a figure which shows a usage of the scraper.

FIG. 7 is a figure which shows the other usage of the scraper.

FIGS. 8A and 8B are perspective views showing a scraper according to another embodiment of the present invention.

### DETAILED DESCRIPTION OF THE INVENTION

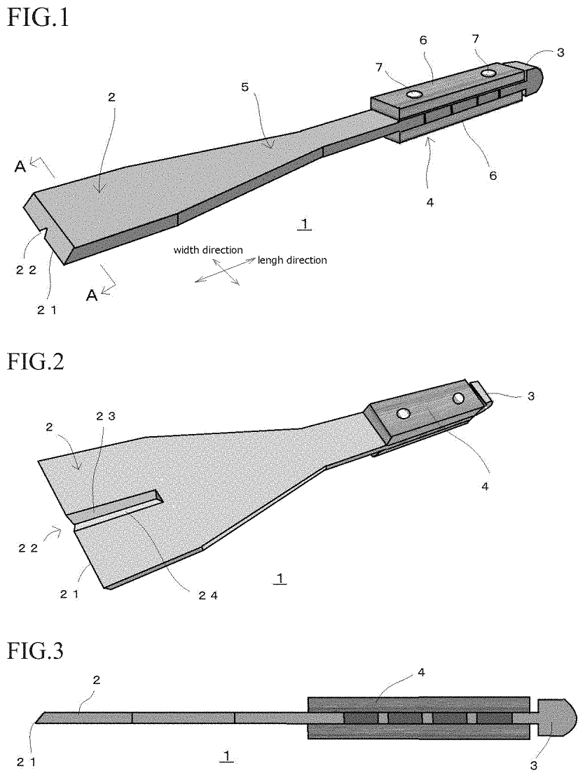

Hereinafter, a scraper according to an embodiment of the present invention will be described with reference to the drawings. In FIG. 1 to FIG. 5, a scraper 1 will be described with a tip side of the scraper as a front surface and a rear side as a back surface.

The scraper 1 comprises a flat blade-shaped blade 2 provided on a tip side, a striking portion 3 provided on a rear end side, and a grip portion 4 provided between the blade 2 and the striking portion 3. A rear end of the blade 2 is integrated with a flat plate-shaped continuous portion 5 extending rearward, and a striking portion 3 is fixed to a rear end of the continuous portion 5.

The striking portion 3 is formed to be thicker than the continuous portion 5, and a hammer is striking the rear end of the striking portion 3. The grip portion 4 is formed by sandwiching a front side and reverse side of the continuous portion 5 with wooden flat plates 6, 6, and fixing the flat plates 6, 6 and the continuous portion 5 with pins 7, 7.

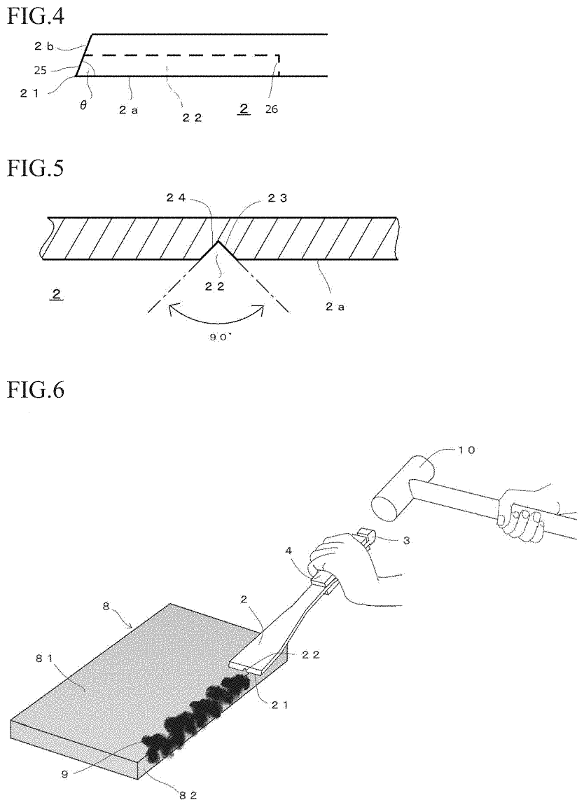

As shown in FIGS. 3 and 4, the blade 2 has one first surface 2a (bottom surface) of a plane along the width direction of the blade 2 and a second surface 2b (front surface) on the tip side connected to the bottom surface. Angle θ formed by those surface 2a, 2b is formed at an acute angle when viewed from the side. An intersecting line of the two surfaces 2a and 2b formed at this acute angle is the cutting edge 21 of the blade 2.

Further, as shown in FIG. 5, a slit 22 extending in the length direction (front-back direction) of the blade 2 is formed on the surface 2a of the blade 2. The slit 22 is opened (25) at the cutting edge 21 and has at least two adjacent first side wall 23 and second side wall 24 extending in the length direction. There is a back wall 26 behind the side walls 23 and 24. The slit 22 may have a length of about 10 to 30 mm, and one slit 22 is formed at the center of the blade 2 in the width direction. The slit 22 is formed in a V-groove whose width narrows toward the inside in the thickness direction of the blade, and the opening angle of the groove is 90°. The opening angle of the groove is appropriately 90°, but is not limited to this.

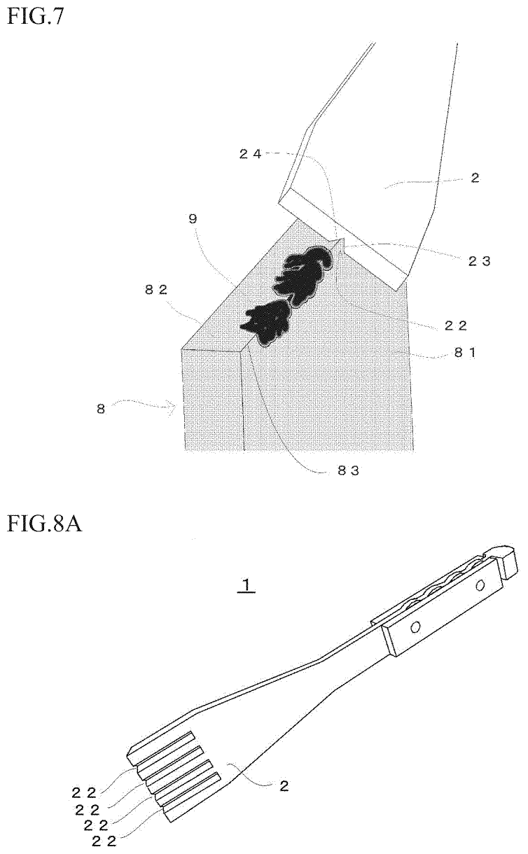

Next, a method of using the scraper 1 will be described with reference to FIGS. 6 and 7. First, a method of grinding a fusing slag 9 (welded material) adhering to a surface 81 of a fusing steel plate 8 (work piece) using the scraper 1 as shown in FIG. 6 will be described.

As shown in FIG. 6, the steel plate 8 is pre-fused, and the fusing slag 9 is attached to the vicinity of the corners of the surface 81 and a cut surface 82 of the steel plate 8 across the surface 81 and the cut surface 82. User of the scraper 1 grips the grip portion 4 with one hand and puts the cutting edge 21 of the blade 2 against the fusing slag 9 on the surface 81. Grasp a hammer 10 with the other hand and hit the hammer 10 against the striking portion 3. Then, the cutting edge 21 is pushed out toward the tip. By pushing the cutting edge 21 toward the tip, the fusing slag 9 is scraped off from the surface 81.

Since the slit 22 is formed in the scraper 1, when the cutting edge 21 is pushed toward the forward, a part of the fusing slag 9 enters the slit 22. Here, since the fusing slag 9 is a molten metal, it is hard and has an irregular shape. Therefore, even if the cutting edge 21 is pushed forward, the blade 2 may slide in the width direction of the blade 2, for example, in the left-right direction.

However, since the slit 22 is formed in the scraper 1, when the cutting edge 21 tries to slide in the left-right direction, the fusing slag 9 that have entered the slit 22 come into contact with the side wall 23 or 24 of the slit 22. Since the side wall 23 or 24 comes into contact with the fusing slag 9 that has entered the slit 22 and cannot move further in the left-right direction, the cutting edge 21 cannot slide in the left-right direction. Therefore, since the movement of the cutting edge 21 in the left-right direction is restricted, the cutting edge 22 can be pushed forward without slipping, and the fusing slag 9 can be accurately ground.

Next, a method of grinding the fusing slag 9 of a corner portion 83 in which the surface 81 of the steel plate 8 and the cut surface 82 are in contact with each other as shown in FIG. 7 will be described. In this case, the slit 22 of the scraper 1 is moved to a position where the fusing slag 9 of the corner portion 83 is not attached, and the corner portion 83 is inserted into the slit 22. At this time, since the slit 22 is formed in the V groove and its opening angle is 90 degrees, the side wall 23 comes into contact with the surface 81, and the side wall 24 comes into contact with the cut surface 82.

Then, when the cutting edge 21 is pushed forward, the fusing slag 9 on the surface 81 side of the corner portion 83 is ground by a tip of the side wall 23, and the fusing slag 9 on the cut surface 82 side of the corner portion 83 is ground by a tip of the side wall 24. As described above, since the slit 22 of the scraper 1 is formed in a V groove having an opening angle of 90 degrees, the scraper 1 can easily grind the fusing slag 9 with respect to the corner portion 83 where it is difficult to grind the fusing slag 9.

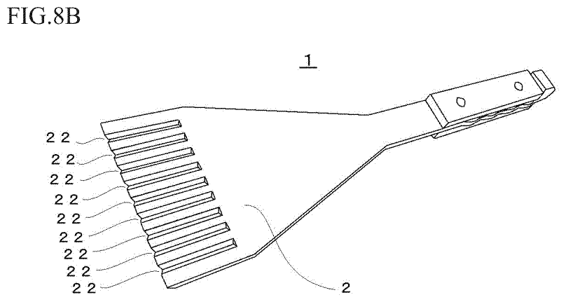

In the present embodiment, one slit 22 is formed at the center of the blade 2 in the width direction, but a plurality of slits 22 may be formed along the width direction. For example, as shown in FIG. 8A, four slits 22, . . . 22 may be formed, and when the width of the blade 2 is long, as shown in FIG. 8B, nine slits 22, . . . 22 may be formed, and the number of slits is not limited. However, with only one of the present embodiments, the scraper 1 is most likely to be subjected to force, and the fusing slag is easily ground.

Further, as shown in FIG. 7, when the opening angle of the V groove of the slit 22 is 90 degrees, the fusing slag 9 of the corner portion 83 of the steel plate is most easily cut, but the angle may be other than 90 degrees. Further, it may be a groove other than the V groove, and may have a cross-sectional viewing trapezoid shape or a semicircular cross-sectional view as long as the movement of the cutting edge in the width direction is restricted by the side wall contacting the fusing slag.

The length of the slit 22 is about 10 to 30 mm, but the length is not limited to this, and if the movement of the cutting edge in the width direction is restricted by the side wall contacting the fusing slag, the length may be 10 mm or less, and 30 mm or more. However, the more the fusing slag is ground, the more the blade 2 is worn down. Therefore, it is desirable that the length of the slit 22 is at least about 10 mm or more so that the blade 2 can be used even if it is worn down.

### EXPLANATION OF SYMBOLS

1 scraper
2 blade
21 cutting edge
22 slit
23 first side wall
24 second side wall
25 opening
26 back wall
2a first side
2b second side
3 strike portion
4 grip portion
5 continuous portion
6 flat plate
7 pin
8 steel plate (work piece)
81 surface
82 cut surface
9 fusing slag (welded material)
10 hammer

1. A scraper for removing a welded material adhering to a work piece, comprising:
a flat blade-shaped blade provided on a tip side of the scraper,
a striking portion provided on a rear end side,
a grip portion provided between the blade and the striking portion, and
a slit extending in the length direction of the blade, which is formed on one surface of a plane along the width direction of the blade, wherein
the slit has an open at the cutting edge and at least two adjacent side walls in the length direction,
the cutting edge of the blade is pressed against the welded material adhering to the work piece by fusing or welding to scrape the welded material from the work piece,
when the cutting edge of the blade is pressed against the welded material, the side wall surface prevents the blade from moving in the width direction when the welded material is inserted into the slit and comes into contact with the side wall.

2. The scraper in accordance with claim 1, wherein
an angle between a first surface of the blade on which the slit is formed and a second surface on the tip side connected to the first surface is an acute angle in side view.

3. The scraper in accordance with claim 1, wherein
the slit is a V-groove whose width narrows toward the inside in the thickness direction of the blade, and an opening angle of the groove is 90 degrees.

4. The scraper in accordance with claim 2, wherein
the slit is a V-groove whose width narrows toward the inside in the thickness direction of the blade, and an opening angle of the groove is 90 degrees.

5. The scraper in accordance with claim 1, wherein
the slit is formed at a center of the cutting edge in the width direction.

6. The scraper in accordance with claim 2, wherein
the slit is formed at a center of the cutting edge in the width direction.

7. The scraper in accordance with claim 3, wherein
the slit is formed at a center of the cutting edge in the width direction.

8. The scraper in accordance with claim 4, wherein
the slit is formed at a center of the cutting edge in the width direction.

9. The scraper in accordance with claim 1, wherein
a plurality of the slit is formed side by side along the width direction of the cutting edge.

10. The scraper in accordance with claim 2, wherein
a plurality of the slit is formed side by side along the width direction of the cutting edge.

11. The scraper in accordance with claim 3 wherein
a plurality of the slit is formed side by side along the width direction of the cutting edge.

12. The scraper in accordance with claim 4, wherein
a plurality of the slit is formed side by side along the width direction of the cutting edge.
